(19) United States
(12) Patent Application Publication
(10) Pub. No.: US 2020/0086471 A1
(43) Pub. Date: Mar. 19, 2020

(54) Hammer head and bit holder adapter for many tools

(71) Applicant: JOSE URRUTIA, SACRAMENTO, CA (US)

(72) Inventor: JOSE URRUTIA, SACRAMENTO, CA (US)

(21) Appl. No.: 16/350,029

(22) Filed: Sep. 17, 2018

(51) Int. Cl. B25F 1/02; B25B 15/00; B25B 23/00; B26B 11/00; B25F 1/00; B23B 45/06; A46B 15/00

(52) U.S. Cl. CPC B25F 1/02; B25B 15/008; B25B 23/0035; B26B 1/08; B25F 1/006; B23B 45/06; A46B 15/0055; B26B 11/00

(57) ABSTRACT

An adapter for disposition in various tool handles to convert the single use tool into a multi-functional tool. The adapter can be added to a tool handle during or post manufacture. The adapter has a domed hammerhead on a threaded shaft, with a square shoulder beneath the head for rotation resistance, a threaded shaft, a normally disposed tubular portion having one or two hexagonal bit holders, one of which may be blocked off, and an optional lower threaded shaft portion. Suitable tools for addition of the adapter include folding knives, box cutters, taping tools, paint brushes, and others with a long single handle for one hand grasping.

### FIELD OF INVENTION

This invention relates to an adapter having several embodiments that can molded into a hand tool handle. The adapter includes a hammer head and one or two bit holders disposed at 90 degrees to the hammer head.

### BACKGROUND OF THE INVENTION

Secondary tool adapters are found in many hand tools. Drywall knives have included pivoting knife blades, and screwdriver bits extending from the handle of the drywall or taping knife. But no tools are as multi-functional as the tools of this invention. See printed applications US 2016/0221174 and US 2015/0026898. The Chacon patent application discloses a screwdriver bit and a dimple forming projection in the handle of a taping tool. The Gringer patent U.S. Pat. No. 6,530,098 has a hammer head at the distal end of the handle of a taping tool. Other tools include various other secondary tools, the leading example of which is the famed Swiss Army knife, which in its various embodiments includes in addition to the two blades, a multitude of other tools, such as wine opener, scissors and small metal file among others.

While the inclusion of secondary tools is seen in the drywall industry, it is also found in other tools as well. Thus Kania in U.S. Pat. No. 9,676,091 discloses a multi-functional tool featuring a wrench head at one end, and a nail puller at the other end of a handle. Various wrench heads are built into the handle.

Such multiple function tools are not confined just to utility patents. Thus the design of Coats features a Multi-functional hand tool combining a shovel, hoe, and jack handle.

Turning to another approach, Meinzer et al U.S. Pat. No. 9,731,409 discloses a handle attached to various implements such as a rake, a brush, or a shovel at one end, and various hand tools attach at the distal end of the handle.

Applicant's invention relates to a hammerhead-bit holder adapter wherein a “hammer” is attached to a shaft to which shaft is attached at right angles a tubular portion for one or two bit holders for either screw driver bits or wrench sockets or hex shaft drills. In reality the hammer portion on a shaft is really a step bolt, which is a carriage bolt having a smooth domed head, and a ribbed square shoulder underneath the head. The shoulder acts to pull into the material into which it is being inserted to prevent spinning. Such bolts are available in the marketplace, hot dipped galvanized, chrome plated, plain steel, or zinc coated as well as stainless steel. Ofttimes they are magnetized as well. Thread size diameter varies in ⅛th inch increments between ¼ to ½ inch. Applicant prefers to use ⅜ths inch diameter as these are readily available. The bit holder portion is adapted to preferably hold ¼ inch diameter bits as these are the most common used in the USA.

This invention can be embedded in the base or handle of various tools, such as but limited to a taping knife for drywall, a hunting knife, a box cutter, a folding pocket knife, even a paint brush, and just about any tool where you can reverse the position of the tool handle in the hand of the user safely such that the second end of the tool can be utilized independently of the main purpose of the tool.

The invention has two embodiments, the first where the tubular portion bit holder is mounted normal to the threaded shaft, and is the terminal point of the invention, and the second aspect has a second threaded shaft portion disposed beneath the bit holder. That is, the tubular portion bit holder is interposed between two threaded shafts of the bolt.

### SUMMARY OF THE INVENTION

This invention relates to an adapter having a domed shaped head carriage bolt to which a bit holder comprising a tubular portion having a hexagonal throughbore adapted to receive drill bits and screwdriver bits having a preferably ¼ inch hexagonal shank is attached. The bit holder can be attached to the threads of the domed carriage bolt at the terminus of the shaft of the bolt, normal thereto by welding the side wall surface of the bit holder to the threads, to create a dual bit holder. In the alternative, one annular end of the tubular portion can be welded shut or closed off during tool handle manufacture to create a single bit holder. The adapter is then placed in a jig and a tool handle molded around it. A second mode of use is to make a first larger diameter bore in the tool handle to receive the optional lower shaft and bit holder and a smaller diameter hole in alignment with the first hole can be made for the balance of the threaded shaft of the adapter. This second mode can be used whether or not there is a lower shaft extension beyond the bit holder.

It is a first object to provide a hammerhead-bit holder adapter that can be molded into a tool handle to provide a hammer head and a single or double bit holder.

It is a second object to provide an adapter that can be added to a conventional tool having a handle which tool is not considered dangerous when the too is turned around for use.

It is a third object to provide an adapter that can be added to conventional tool handles by drilling suitable bores and glueing and threading the adapter into suitable 2 level bore.

It is a third object to provide a tool adapter to convert a multiplicity of single use conventional tools into multi-functional tools.

It is a fourth object to provide a hammerhead-bit holder adapter to convert a taping knife, a box cutter, and a hunting knife, and a pocket knife into hammers and screw drivers.

It is a fifth object to convert a paint brush into a combination paint brush-hammer and releaseable blade screwdriver.

Other objects of the invention will in part be obvious and will in part appear hereinafter. For a fuller understanding of the nature and objects of the invention, reference should be made to the following detailed description, taken in conjunction with the accompanying drawings.

For a fuller understanding of the nature and objects of the invention reference should be made to the following detailed description taken in conjunction with the accompanying drawings

The invention accordingly comprises the device possessing the features, properties and the relation of components which are exemplified in the following detailed disclosure and the scope of the application of which will be indicated in the claims

### BRIEF DESCRIPTION OF THE FIGURES

FIG. 1 is a perspective view of the first embodiment of the hammerhead-bit holder adapter of this invention, wherein the bit holder is disposed at the terminus of the carriage bolt threaded shaft and is dual ended.

FIG. 2 is a left side perspective view of the second embodiment of the hammerhead-bit holder adapter, wherein the bit holder is disposed interposed between a first and second threaded shaft portion and is a dual bit holder.

FIG. 3 is a right perspective view of the second embodiment of this invention, wherein the bit holder is disposed interposed between a first and second threaded shaft portion.

FIG. 4 is a variant of the adapter of FIG. 1, wherein the bit holder is a single bit holder.

FIG. 5 is a variant of the adapter of FIG. 2 wherein the bit holder is a single bit holder.

FIGS. 6A & 6B are top plan and end views respectively of a taping knife with a cutaway area showing a single bit holder adapter of this invention.

FIGS. 7A & 7B are top plan and end views respectively of a taping knife with a cutaway area showing a hammerhead-dual bit holder adapter of this invention.

FIG. 8 is a perspective view of a box cutter having the adapter of this invention disposed therein and showing the hammer head and one bit holder.

FIG. 9 is a right side view of a paint brush having the invention of this application embedded in the handle of the paint brush and showing the hammer head and a dual bit holder.

FIG. 10 is a side view of a fishing/hunting knife containing the invention of this application shown partially in dashed lines.

FIG. 11 is a bottom perspective view of a pocket knife showing this invention therein in a cutaway area, and the dome hammerhead shaved down to fit the tool.

FIG. 11A depicts a variant of the knife shown in FIG. 11 with the full dome hammerhead.

FIG. 12 is top view of a ½ mold for a tool handle for receipt of an adapter of this invention with access openings to the bit holder plugged up for during the molding process.

FIG. 13 is a sectional view of a tool handle showing the dual depth aligned bore for an adapter of this invention to be placed into a solid wood or plastic tool handle.

### DESCRIPTION OF THE PREFERRED EMBODIMENT

Let us turn first to FIG. #1. Here the first embodiment of the hammerhead-bit holder adapter of this invention 10, is seen. The device comprises a step bolt having a domed head 11, beneath which is a square shoulder 12, followed in turn by a threaded shaft 13. Welded, glued or other wise attached normal to the threaded shaft is a quarter inch tubular portion bit holder, 15 having an internal hexagonal opening 17 at one end and a similar opening 19, at the second end of the tube.

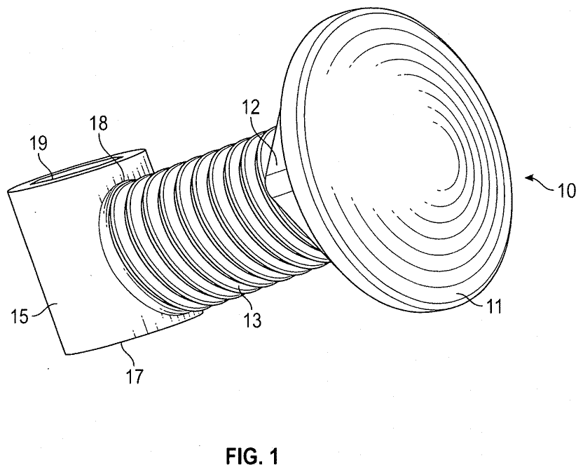

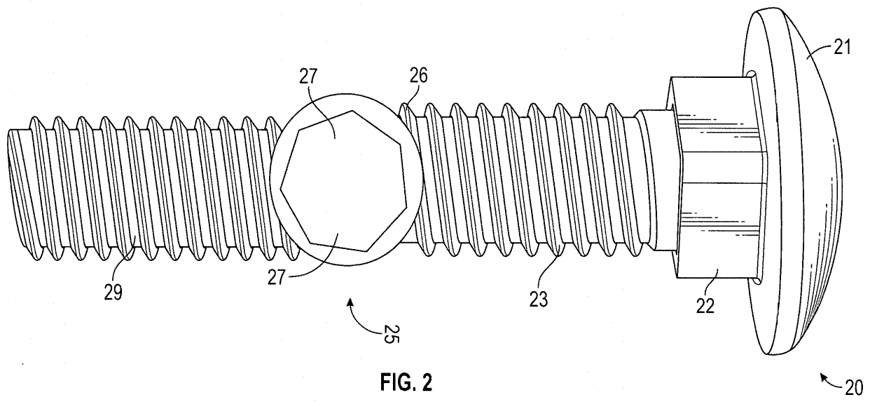

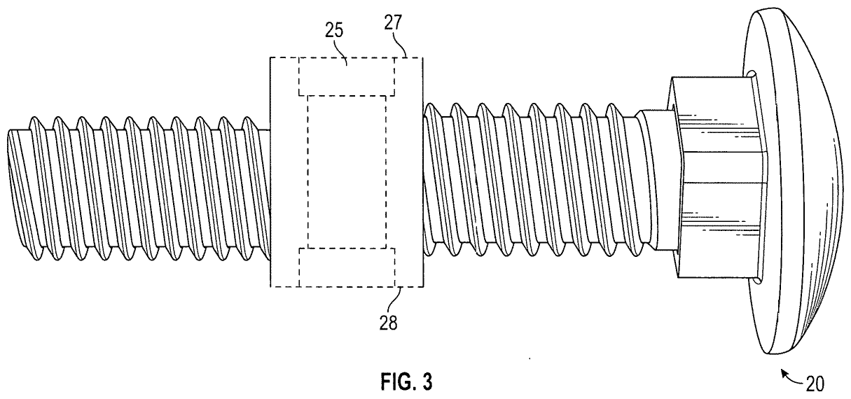

FIG. 2 depicts a second embodiment of this invention, 20. This adapter unit has a domed shaped head 21, a square shoulder 22, followed by an integral first threaded shaft 23. The tubular portion 25 is disposed in like manner as in FIG. 1, normal to and centered on the threaded shaft 23. Disposed beneath the tubular portion is a lower or second threaded portion 29. The purpose of the second threaded portion is to provide additional holding power in any tool handle for the adapter. Tubular portion 25 has an internal hexagonal opening 27 that holds bits or screwdrivers or drills.

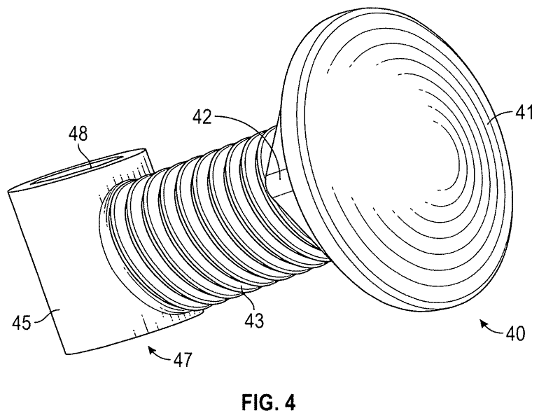

FIG. 3 is related to FIG. 2, but is a view of the front face of the adapter. Here hexagonal opening 27 is seen in dotted lines in adapter 25 as well as hexagonal opening 28 opposed from opening 29.

In FIG. 4, we see a variant of the device of FIG. 1. Here like parts bear similar related numbers but in the 40's series. Thus the domed head is 41 for invention 40. The shoulder beneath the head is designated 42 and the first and only threaded shaft is 43. The tubular portion is welded normal to the distal end of the threaded shaft 43 and said tubular portion is designated 45. Here, the tubular portion 45 has a hexagonal opening 47 but the opposite end is closed of and designated 48. There are instances where only a single bit holder section of the device can be utilized due to the tool's innate construction.

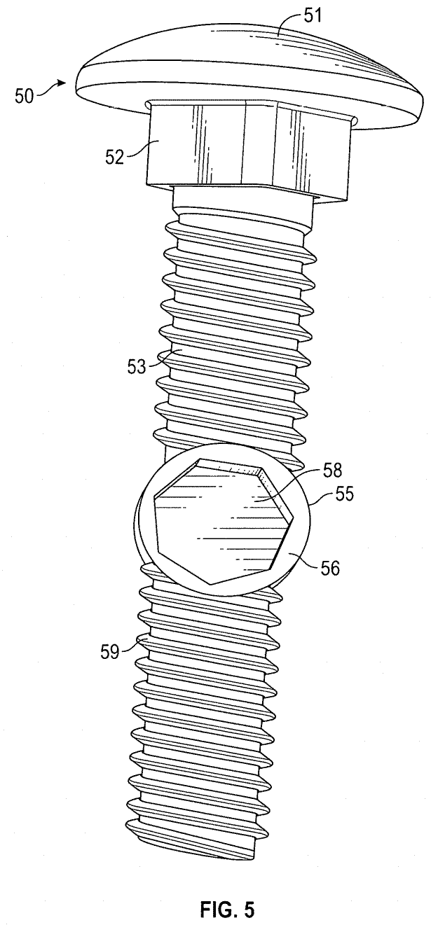

FIG. 5 is related to FIGS. 2 & 3 and is numbered in the 50's. Head 51 has a square shoulder 52 beneath it, followed by a first threaded shaft 53. The tubular portion 55 is disposed normal to the first threaded shaft, 53. A second or lower threaded shaft 59, of the same diameter as the first threaded shaft is welded in alignment to the first threaded shaft here, as well as in all other adapters that have the lower threaded shaft. One end of the tubular portion 55, is open and the other end seen here and designated 56, is closed off by a wall 58.

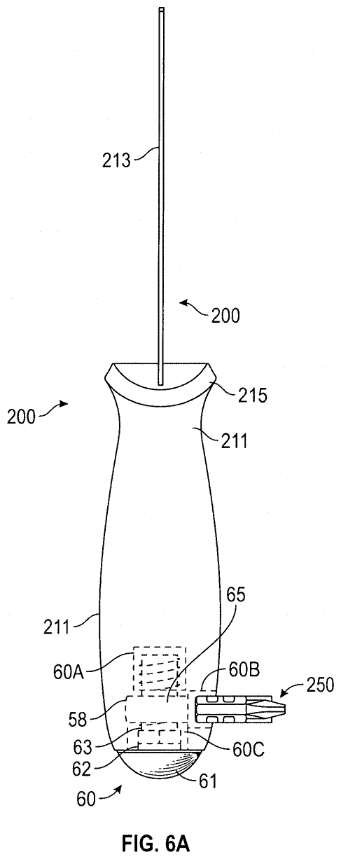

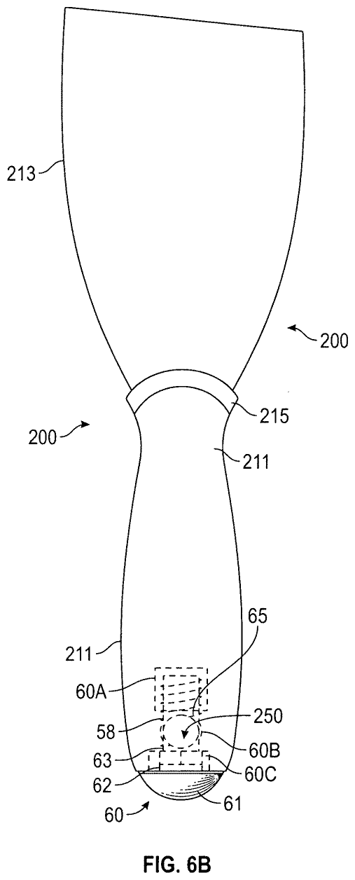

We now turn to the use of these devices in tools and tool handles. FIG. 6A is a top plan view of a typical drywall installer's taping knife, 200 whose blade width can vary from 1 to 12 inches wide. It has a handle 211, a ferrule 215 and a blade 213. Such tools are deemed conventional and can be purchased at such stores as paint stores and big box places like Lowe's® and Home Depot®. The handle has been bored out to receive a device 60 of this invention. The bore 60A shown in dashed lines in the handle 211 is equal in width to the width of the threaded shaft aspect 65 of the device 60. A side bore 60B also shown in dashed lines communicates with the hammerhead bit holder adapter of this invention's tubular portion 65. A Phillips head screwdriver bit is shown spaced slightly distant from the hexagonal opening of the tubular portion just prior to engagement. When so engaged, the handle would be grasped with the blade facing the user, such that screwdriver bit could be used as needed to engage a screw into a substrate. The hammerhead section is designated 61. At the second end of tubular portion 65, a wall 58 closes off the end of the tubular portion 65 distant from 60B. Area 60C denotes to width of the bore for the opening to allow adding the tubular portion to the tape knife handle. This area is equal in distance across as the tubular portion 65, See also FIG. 6B, a side view related to FIG. 6A

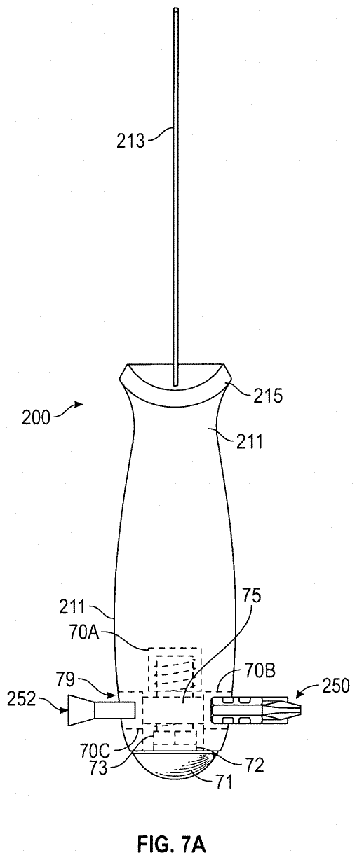

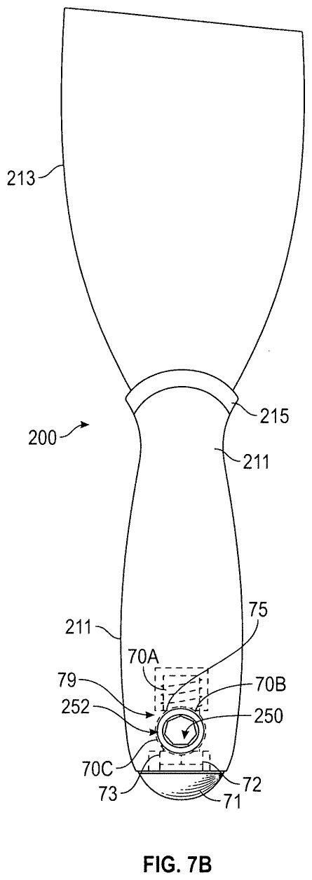

FIG. 7A is related to FIG. 6A and as such many of the numbers are the same as the parts in FIG. 6A. Here however the tubular portion, 65 is open at both ends to provide the ability to have two different bits therein at the same time. Thus instead of wall 58, there is a second opening to the tubular portion 75, designated 70C, where a flat blade screwdriver bit 252 is seen spaced from the hexagonal opening 79, which is not directly visible in this view. All other parts that in FIG. 6 were numbered in the 60's, are here numbered in the 70's with like second digits. Thus in FIG. 7A, the hammerhead is numbered 71 and the shoulder 72. See also FIG. 7B.

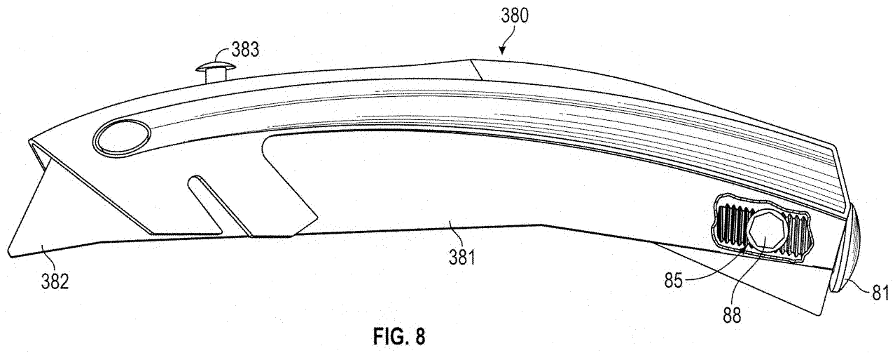

In FIG. 8 there is seen a conventional box cutter knife, 380, with retractable blade 382 and a knife body 381 seen in a perspective view. The hammerhead 81 is disposed at the rear of the tool and a hexagonal opening 88 in a tubular portion 85 is seen in a cutaway zone of the FIGURE. Designator 383 is a conventional blade slider mechanism found in this type of tool. Section 384 of the knife body permits the hammerhead 81 to be flush on its bottom with the knife body.

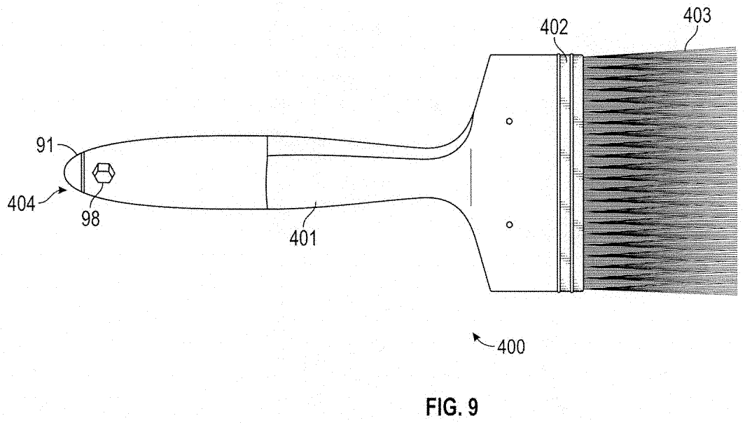

In FIG. 9, we turn from cutting tools to a paint brush which has been adapted to become a multi-purpose tool. By utilizing a brush with a relatively large handle, it becomes easy to bore out the space necessary to receive the adapter of this invention in the proximal end of the brush handle. Thus brush 400 has a handle 401 with a ferrule 402 to hold the bristles 403. Ferrule 402 is a brass or other metal strip that fits tightly around the end of the brush handle and the bristles to hold the bristles in place. This is conventional paint brush construction. At the proximal end 404, is seen the hammerhead section 91, of the adapter, with a hexagonal opening for a bit 98, seen on one face of the brush handle.

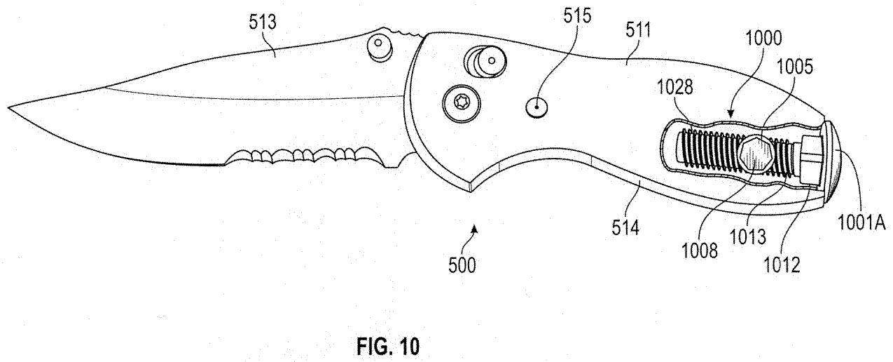

In the following FIGURES, there are illustrated non-business oriented tools, namely a hunting/fishing knife and a folding pocket knife that can be adapted to become multi-functional tools. Thus in FIG. 10 there is seen typical hunting/fishing knife available from many vendors. This knife 500 has a handle 511 and a retractable blade 513 that can fold into slot 514. The handle is formed of two parts held together in part by screw 515. Within the interior of handle 511 and shown in dashed lines is adapter 1000. It includes shoulder, 1012, first threaded shaft 1013, second threaded shaft 1028, the latter two both attached o the tubular portion 1005 having the hexagonal opening 1008. The dome hammerhead is designated 1001A, in view of the fact that for cosmetic purposes, part of the dome have been shaved off in the FIGURE. Note however, that such trimming is optional depending on the thickness of the knife handle. If a full size hammerhead were to be employed, it would be designated 1001. The reason for the shaved hammerhead 1001A is to not have any of the head 1001A extend beyond the width of the knife handle.

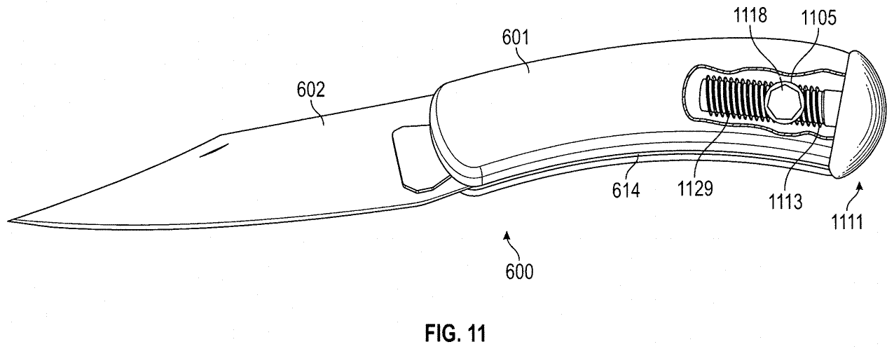

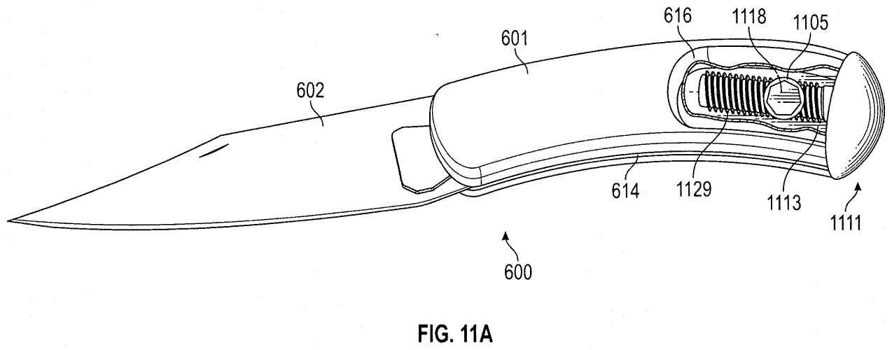

The discussion now moves to FIG. 11, which shows a conventional folding pocket knife carried by many men and boys. Knife 600 has a handle 601 and a folding blade 602 that folds into slot 614. This knife has a thicker handle and can therefore accommodate the adapter with the full domed hammerhead section 1111. The shoulder is present but not seen in this view which depicts a cutaway of the knife handle to reveal the balance of the adapter of this invention. Seen here are first threaded shaft 1113, lower threaded shaft portion 1129 and hexagonal opening 1118 in tubular portion 1105. The dome has been shaved down to fit the thickness of the knife handle. The analogy is the slicing off of the ends of the button of a mushroom to create what would be designated a truncated mushroom button.

In order to demonstrate that this technology will work in a typical conventional folding pocket knife, but without a shaving or reduction in size of the hammerhead aspect of the adapter, reference is made to FIG. 11A. Here the body of the knife itself has been built up with additional resin on the handle, such as polyurethane—easy to grab rubbery polymer or polyethylene-more traditional plastic used in tool handles—at the rear of the handle such that a complete domed hammerhead can be employed. The added polymer buildup is designated 616. This permits the full dome shaped hammerhead to be employed as the hammer without any reduction as shown in FIG. 11.

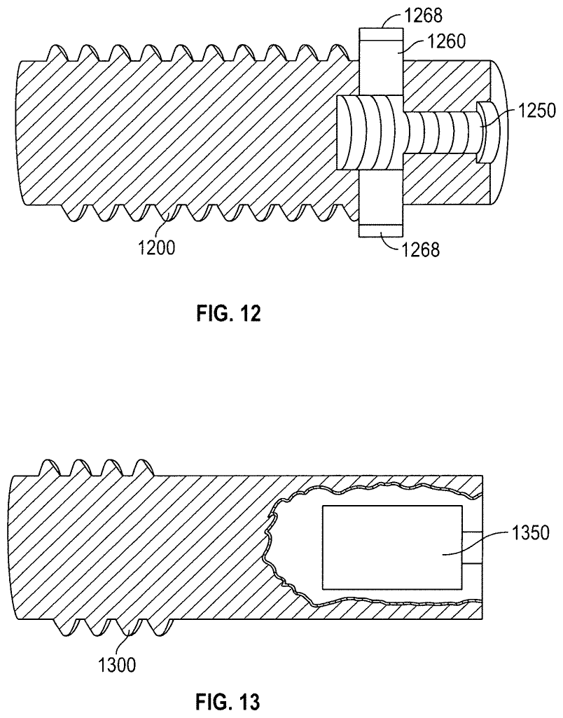

FIGS. 12 and 13 illustrate two modes of tool production that can add the adapter of this invention to a tool handle. In FIG. 12. There is seen a half of a mold 1200 having ½ of a cavity 1250 specifically shaped for the adapter of this invention. This ½ mold has two openings 1260 on opposite sides of the aligned tubular portion of the adapter. These openings 1260 are closed off by plugs 1268 which when pulled will leave access areas to the tubular portion of the adapter of this invention. The second half of the mold which is a mirror image of the mold part shown in FIG. 12 is not seen. FIG. 13 on the other hand depicts a cutaway view of a solid handle 1300 which has been bored out to make a cavity 1350 for an adapter of this invention. Opening 1350 has a width equal to the width of the tubular portion of the adapter, and which is then filled in with resin to surround the lower threaded shaft portion of the adapter to lock the adapter in place when the resin hardens.

It is believed that other modes of adapting tool handles to accept the adapter of this invention also exist. Only two of such modes have been illustrated here.

In conclusion the adapter of this invention can be added to a multiplicity of tools both after the purchase of the tool if the handle is of sufficient girth to hold the adapter internally by making proper bores to the handle and inserting the adapter and sealing it in place; as well as adding the adapter during the manufacturing process of the tool as illustrated in the last two Figures and their discussion.

Preferably the hexagonal bit holder aspect of the tubular portion should preferably be for ¼ inch screw drivers or hex shanked drill bits the latter for the starting of holes prior to using an electric drill with a bit of the size needed for the job. The dome head can vary from about ¾ths inch in diameter to about 1.0 inches. When shaved ala mushroom trimming as discussed above, the sliced of amount will vary with the thickness of the basic tool being modified to be multi-functional. Another way to describe the reshaping of the domed hammerhead is truncation.

The preferred threaded shaft thickness is about ⅜ths inch, but larger or smaller may be employed. The lower threaded shaft if present for added rigidity should preferably be of the same diameter as the first threaded shaft attached to the shoulder. Preferably any and all bit holders are magnetic for better temporary retention of bits and drivers.

Since certain changes may be made in the above devices without departing from the scope of the invention herein involved, it is intended that all matter contained in the above description and shown in the accompanying drawings shall be interpreted as illustrative and not in a limiting sense.

I claim:

1. An adapter for addition to tool handles either post or pre manufacture of the tool, to convert the tool to a multi-functional tool, which adapter comprises: a domed shaped head carriage bolt, having a square shoulder and a first threaded shaft, a tubular portion having from 1 to 2 hexagonal bit holders, said tubular portion being attached normal to and at the end of the threaded shaft distant from the shoulder.

2. The adapter of claim 1 wherein a lower threaded shaft is attached in alignment with the first threaded shaft, spaced from said first threaded shaft by the tubular portion.

3. The adapter of claim 1 wherein there are two hexagonal bit holders in the tubular portion.

4. The adapter of claim 1 wherein there is one hexagonal bit holder in the tubular portion, with the location of the second bit holder being walled off.

5. The adapter of claim 2 wherein there are two hexagonal bit holders in the tubular portion.

6. The adapter of claim 2 wherein there is one hexagonal bit holder in the tubular portion, with the location of the second bit holder being walled off.

7. A multi-functional cutting knife having a folding blade for retention within a handle of the cutting knife, wherein the end distant from the blade houses an adapter to convert the said knife to a multi-functional tool, which adapter comprises: a domed shaped head carriage bolt, having a square shoulder and a first threaded shaft, a tubular portion having from 1 to 2 hexagonal bit holders, said tubular portion being attached normal to and at the end of the threaded shaft distant from the shoulder, with or without a lower threaded shaft attached in alignment with the first threaded shaft, spaced from said first threaded shaft by the tubular portion, whereby the knife can be used as a hammer, a screw driver or manual drill.

8. The multi-functional cutting knife of claim 7 wherein the knife is a hunting/fishing knife.

9. The multi-functional cutting knife of claim 7 wherein the knife is a folding pocket knife.

10. A multi-functional drywall taping knife, having a blade retained by a ferrule to a handle, the handle of which at the end opposite the blade thereof, has embedded therein an adapter to convert the said taping knife to a multi-functional tool, which adapter comprises: a domed shaped head carriage bolt, having a square shoulder and a first threaded shaft, a tubular portion having from 1 to 2 hexagonal bit holders, said tubular portion being attached normal to and at the end of the threaded shaft distant from the shoulder, with or without a lower threaded shaft attached in alignment with the first threaded shaft, spaced from said first threaded shaft by the tubular portion whereby the taping knife can be used as a hammer, a screw driver or manual drill.

11. The multi-functional taping knife of claim 10 wherein the blade varies from 1.50 inches in width to 4 inches in width, and the bit holder accepts ¼ inch bits and screwdrivers.

12. The multi-functional taping knife of claim 11 wherein the blade varies from 1.50 inches in width to 4 inches in width, and the bit holder that accepts ¼ inch bits and screwdrivers has two bit holder hexagonal openings extending from opposite faces of the tape knife handle.

13. A multi-functional paint brush, having a set of bristles retained by a ferrule to a handle, the handle of which at the end opposite the bristles thereof, has embedded therein an adapter to convert the said paint brush to a multi-functional tool, which adapter comprises: a domed shaped head carriage bolt, having a square shoulder and a first threaded shaft, a tubular portion having from 1 to 2 hexagonal bit holders, said tubular portion being attached normal to and at the end of the threaded shaft distant from the shoulder, with or without a lower threaded shaft attached in alignment with the first threaded shaft, spaced from said first threaded shaft by the tubular portion whereby the paint brush can be used as a hammer, a screw driver or manual drill.

14. The multi-functional paint brush of claim 13 wherein there are two bit holder hexagonal openings extending from opposite faces of the paint brush handle.

15. The paint brush of claim 14 wherein the bit holders are magnetic.

16. The taping knife of claim 12 wherein the bit holders are magnetic.

17. A multi-functional cutting knife as in claim 7, wherein the knife's blade is retractable into the handle instead of being foldable into the handle.

18. The taping knife of claim 15 wherein the tape knife width may range from 1 inch to 12 inches.

19. The multi-functional cutting knife of claim 17 wherein the dome of the hammerhead portion has been truncated.
